(19) United States
(12) Patent Application Publication
(10) Pub. No.: US 2002/0127085 A1
(43) Pub. Date: Sep. 12, 2002

(54) Double-tech self-drilling screw

(76) Inventor: Arthur Field, Gardena, CA (US)

Correspondence Address: Roger A. Marrs, Suite 1220, 15233 Ventura Blvd., Sherman Oaks, CA, 91403, US

(21) Appl. No.: 09/932,324

(22) Filed: Aug. 20, 2001

Related U.S. Application Data
(60) Provisional application No. 60/219,142, filed on Jul. 17, 2000.

(51) Int. Cl. F16B 25/10

(52) U.S. Cl. 411/387.6

(57) ABSTRACT

A cutting and locating point for a screw having an elongated threaded shank terminating in a tapered drilling portion including a pair of spiral flutes each with primary cutting edges separated by flats having a split-point geometry and a pair of secondary tip cutting edges. The primary cutting edges create an immediate centering of the screw point and perform the work of cutting a hole for entrance of the screw shank into the workpiece while the secondary cutting edges create a self-centering point of contact with the workpiece so that the screw point will not slide or “walk” one way or another. The flats are disposed between the primary cutting edges and are preferably within a range of 115 degrees to 145 degrees of taper establishing a point angle.

### BACKGROUND OF THE INVENTION

1. Field of the Invention

The present invention relates to the field of rotary cutting implements used in the construction industry, and more particularly to a uniquely pointed screw having self-drilling capability and which incorporates an integrated split-point geometry to provide self-centering and self-starting characteristics.

2. Brief Description of the Prior Art

In the past, difficulties and problems have existed in providing a suitable tip for a standard screw which incorporates self-centering and self-drilling capability. In most conventional screw tips, no means are incorporated for preventing a “corkscrewing” or “walking” effect which is common to most standard point configurations for the drill point. Although some of the prior standard point screw tips have been provided with a central tip for locating, piercing or feeding purposes, none of the prior standard point screw tips combine a cutting or locating structure which provides for simultaneous self-drilling and self-centering, as well as self-starting characteristics. The result of prior standard point screw tips not having these qualities or capabilities results in a substantial increase in torque developed when seeding a screw as compared to the inventive concept which includes cooperative structure for providing both self-drilling and self-centering as well as starting characteristics.

Therefore, a long-standing need has existed to provide a novel fastener of the screw type which includes a cutting and locating structure on the tip of a screw which is capable of self-drilling and which incorporates or is integrated with split-point geometry for providing self-centering and starting characteristics.

### SUMMARY OF THE INVENTION

Accordingly, the above problems and difficulties are avoided by the present invention which provides a novel cutting and locating point for a screw which has an elongated threaded shank terminating in a tapered drilling portion which is provided with a pair of spiral flutes each with primary cutting edges separated by flats having a split-point geometry and a pair of secondary tip cutting edges. The primary cutting edges create an immediate centering of the screw point and perform the work of cutting a hole for entrance of the screw shank into the workpiece while the secondary cutting edges create a self-centering point of contact with the workpiece so that the screw point will not slide one way or another in “walking” fashion. The flats are disposed between the primary cutting edges and are preferably within a range of 115 degrees to 145 degrees of taper establishing a point angle.

Therefore, it is among the primary objects of the present invention to provide a screw-type fastener which has chisel cutting edges that will increase the holding power by wedging into the material of the workpiece rather than cutting it clean.

Another object of the present invention is to provide a screw-type fastener having a split-point geometry for its drilling portion which is self-drilling whereby different degrees of hole opening are achieved at the greatest speed in order to reduce cutting and drilling time and allowing the fastener to tap a seal in a permanent holding position.

Yet another object of the present invention is to provide a novel drilling portion for a screw fastener having chisel cutting edges so as to create an immediate centering of a screw point and which further includes self-centering characteristics which will start an immediate hole and will not slide one way or another.

A further object resides in providing a self-drilling and self-centering tip for a screw which requires less torque when seeding the screw as compared to conventional self-drilling screws creating fastener positive drill mounting.

### BRIEF DESCRIPTION OF THE DRAWINGS

The features of the present invention which are believed to be novel are set forth with particularity in the appended claims. The present invention, both as to its organization and manner of operation, together with further objects and advantages thereof, may best be understood with reference to the following description, taken in connection with the accompanying drawings in which:

FIG. 1 is an enlarged side elevational view of a drilling portion or tip carried on the end of a shank of a screw-type fastener;

FIG. 2 is a bottom view of the drilling portion or tip shown in FIG. 1;

FIG. 3 is a side-elevational view of the tip end shown in FIG. 1;

FIG. 4 is a side-elevational view taken from the opposite side as shown in FIG. 3;

FIG. 5 is a side-elevational view illustrating the use of the drilling portion or tip shown in FIGS. 1 and 2 for different screw-type fasteners.

FIG. 6 is an enlarged side-elevational view of another version of a screw-type fastener tip; and

FIG. 7 is a bottom view of the drilling portion or tip of the screw-type fastener shown in FIG. 6.

### DESCRIPTION OF PREFERRED EMBODIMENT

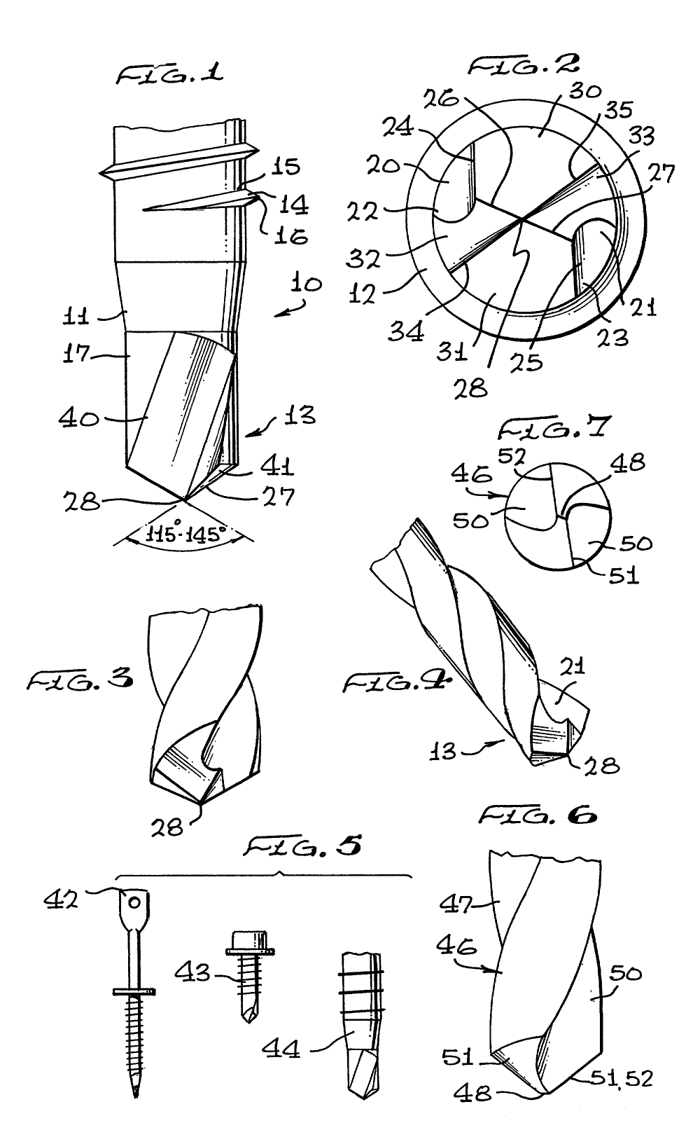

Referring now in detail to FIGS. 1 and 2, the self-drilling and self-centering as well as self-starting screw is illustrated in the general direction of arrow 10 and is illustrated as including an elongated shank portion 11 which is formed at one end with an appropriate driving head 12 and at its other end with a drilling portion 13. The shank portion 11 is fabricated to provide helical thread convolutions 14 thereon. These convolutions preferably extend from adjacent the driving head to the drilling portion 13 and being formed to provide a root diameter 15 which is substantially coincident with the outer surface of the shank portion 11 and a crest diameter 16.

The drilling portion 13 is formed preferably by a forging operation to provide a generally cylindrical body 17 which preferably has a maximum diameter which is slightly less than the root diameter of the threads.

The body 17 is formed with longitudinally extending flutes 20 and 21, as best shown in FIG. 2, which are located substantially on opposite sides of the body 17. Each flute comprises an elongated recess in the body 17 which is defined by angularly joined substantially planar wall surfaces 22 and 23 in substantially right-angled relationship. The flute surfaces in each case being outwardly terminated and defining a rectilinear primary cutting edge, identified by numerals 24 and 25, of each flute. Each flute also terminates in a secondary tip-cutting edge, identified by numerals 26 and 27, again associated with each flute. The secondary cutting edges 26 and 27 converge to join at a center point 28. The flutes are separated by flats 30 and 31 which form part of the tapered point and merge with edges 26 and 27. Additional flats 32 and 33 separate flats 30 and 31 and merge together at edges 34 and 35 respectfully. It is to be particularly noted that the cutting edges 26 and 27 form the secondary tip-cutting edges and that edges 34 and 35 are employed for centering purposes and not for cutting.

The fastener head 12 to which a turning tool may be engaged may be provided with various sizes and shapes of head. For example, the head may take the form of a Phillips head, a straight head, a hex head, a lag head, a drop sealing head or the like. Also, the screw threads may be of a standard size or of a metric thread. The size of the thread must be slightly larger than the shank diameter and for best results, the thread size will be tap sizes off the standard metals drill-to-tap chart.

The area indicated by numeral 40 shows the chisel edge of the drill itself. On lightweight metals, it will leave enough material to help grab the threaded portion of the fastener. It will also increase the holding power by wedging into the material rather than cutting it clean. The drill size will be determined by the thickness of material or workpiece.

Numeral 41 indicates the point portion of the self-drilling screw in FIGS. 1, 3 and 4, which can be of different degrees to open the workpiece hole at the greatest speed to reduce cutting and drilling time which allows the fastener to tap in a permanent holding position. The point 28 illustrates the proposed various degrees of drill point which is available to incorporate the best results of the invention. The drill point degree depends on material or workpiece hardness and thickness. The diameter will also be changed depending on the type of material into which the screw is driven.

The self-centering characteristic of the present invention will start an immediate hole and the drill point will not slide one way or the other. This will require less torque when seeding the screw as compared to conventional self-drilling screws. It is a vast improvement over the conventional standard drill or screw point on all present self-drilling screws. The chisel head has two distinct points which create a self-centering point adjacent to the flutes, and as indicated by cutting edges 26 and 27.

FIG. 5 illustrates that the tip portion of a variety of screws is within the scope of the present invention. The different screws are indicated by numerals 42, 43 and 44. As noted earlier in the description, the fastener head 12 may take various forms.

FIGS. 6 and 7 illustrate a further version of the invention in which the tip 46 includes a flat or chisel edge 48 with curved cutting sides or edges 51, 52 and flutes 47 and 50. Tapered surfaces 53 and 54 are separated by the flat edge 48 at the tip and laterally by flutes 47 and 50. The surfaces 53 and 54 are referred to as smooth and actuate about the longitudinal central axis of the shank.

While particular embodiments of the present invention have been shown and described, it will be obvious to those skilled in the art that changes and modifications may be made without departing from this invention in its broader aspects and, therefore, the aim in the appended claims is to cover all such changes and modifications as fall within the true spirit and scope of this invention.

What is claimed is:

1. A drill screw having integrated split-point geometry and having self-centering and self-starting characteristics comprising:
a threaded shank;
a drilling portion provided at one end of said shank and a head provided at an end opposite to said one end;
said drilling portion having a body extending axially from said one end of said shank;
said body terminating in a drilling tip extending forwardly from said body and having a pair of diametrically opposite axially extending flutes;
cutting edges provided by said flutes including end cutting edges at said one end of said shank;
inclined cutting edges extending angularly from said cutting edges on said flutes to terminate at said drilling tip; and
said inclined cutting edges separated by a pair of tapered surfaces and disposed between said pair of flutes.

2. The drill screw defined in claim 1 wherein:
said drilling tip constitutes a chisel head having a pair of distinct points providing a self-centering point location.

3. The drill screw defined in claim 2 wherein:
said drilling tip provides a drill point center at said one end of said shank.

4. The drill screw defined in claim 3 wherein:
said pair of flutes terminate at said body with a pair of spaced-apart chisel edges that are flat in a lateral disposition and communicate with said inclined cutting edges.

5. The drill screw defined in claim 4 wherein:
said drill tip is a flat edge having opposite ends terminating at said inclined cutting edges so as to define a chisel edge providing self-centering and self-starting characteristics.

6. The drill screw defined in claim 5 wherein:
said flute cutting edges and said included cutting edges lie in a diametrical axial plane of said drilling portion while cooperating to provide cutting surfaces at said drilling tip with said chisel edge.

7. In a self-centering and self-starting drill screw having an elongated threaded shank with a longitudinal axis and a driving head at its rearward end and a drilling portion having a tip at its forward end, the improvement comprising:
said drilling portion having a body with two longitudinally extending flutes located substantially on opposite sides of said body;
a side cutting edge provided on each flute intersecting at said tip to define an outer drill center; and
said outer drill center being a chisel edge having opposite ends joining with said side cutting edges respectively.

8. The drill screw defined in claim 7 wherein:
said body further includes a pair of inclined cutting edges carried on said drilling tip disposed between said flutes.
